(19) United States
(12) Patent Application Publication
(10) Pub. No.: US 2014/0300914 A1
(43) Pub. Date: Oct. 9, 2014

(54) INFORMATION PROCESSING APPARATUS, METHOD FOR CONTROLLING THE SAME, AND RECORDING MEDIUM

(71) Applicant: CANON KABUSHIKI KAISHA, Tokyo (JP)

(72) Inventor: Daisuke Yamazaki, Kawasaki-shi (JP)

(73) Assignee: CANON KABUSHIKI KAISHA, Tokyo (JP)

(21) Appl. No.: 14/181,264

(22) Filed: Feb. 14, 2014

(30) Foreign Application Priority Data
Feb. 20, 2013 (JP) 2013-030676

(51) Int. Cl. G06F 3/12; G06F 3/0481; H04N 1/00

(52) U.S. Cl. CPC G06F 3/1204; H04N 1/00474; H04N 1/00503; G06F 3/1206; G06F 3/1254; G06F 3/0481; H04N 2201/0039; H04N 2201/0094
USPC 358/1.13

(57) ABSTRACT

An information processing apparatus includes a determination unit, a creation unit, and an instruction unit. The determination unit determines whether any printer object has been added. The creation unit creates, if the determination unit determines that a printer object has been added, a virtual device object corresponding to the added printer object. The instruction unit receives from a user an instruction for linking a file to the created virtual device object. A printer driver corresponding to the printer object outputs output information to an image processing apparatus after the instruction unit has accepted the received instruction from the user for linking the file to the virtual device object.

### BACKGROUND OF THE INVENTION

1. Field of the Invention

The present invention relates to an information processing apparatus, a method for controlling the same, and a program.

2. Description of the Related Art

In the case of outputting print information from a personal computer (PC) to a multifunction peripheral device including an image processing apparatus, it is generally instructed to open an output document by an application and output it via a printer driver. However, to improve convenience in outputting the document to the multifunction peripheral device more, there is available a technology for integrating a plurality of printer drivers as a virtual device.

One example is a technology for integrating printer drivers corresponding to a plurality of different devices as a virtual device according to a user's integration instruction and enabling the outputting from the virtual device to facilitate the printing distributed to the plurality of devices (Japanese Patent Application Laid-Open No. 2006-215725).

In the technology discussed in Japanese Patent Application Laid-Open No. 2006-215725, according to the user's combining instruction, a plurality of printer objects are integrated to create a virtual device. To add a new printer objet to a system to use it as a virtual device, the user must instruct combining of the printer object. Such an operation is cumbersome, and the virtual device which can be used more easily is desired.

### SUMMARY OF THE INVENTION

The present invention is directed to a mechanism for determining the addition of a printer object and registering the printer object in a virtual device object by a simple operation.

According to an aspect of the present invention, an information processing apparatus includes a determination unit configured to determine whether any printer object has been added, a creation unit configured to create, if the determination unit determines that a printer object has been added, a virtual device object corresponding to the added printer object, and an instruction unit configured to receive from a user an instruction for linking a file to the created virtual device object, wherein a printer driver corresponding to the printer object outputs output information to an image processing apparatus after the instruction unit has accepted the received instruction from the user for linking the file to the virtual device object.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating a configuration of a data processing system.

FIG. 2 is a diagram illustrating a hardware configuration of an information processing apparatus.

FIG. 3 is a diagram illustrating an example of a functional configuration of a virtual device application.

FIG. 4 is a diagram illustrating an example of a user interface (UI) screen displayed on a display unit.

FIG. 5 is a diagram illustrating a relationship between a virtual device object and a printer object.

FIGS. 6A and 6B are diagrams each illustrating a changed state of the UI screen displayed on the display unit.

FIGS. 7A, 7B, and 7C are diagrams illustrating an example of the UI screen displayed on the display unit.

FIGS. 8A and 8B are flowcharts each illustrating a method for controlling the information processing apparatus.

FIG. 9 includes FIG. 9A and FIG. 9B and is a flowchart illustrating the method for controlling the information processing apparatus.

### DESCRIPTION OF THE EMBODIMENTS

Various exemplary embodiments, features, and aspects of the invention will be described in detail below with reference to the drawings.

<System Configuration>

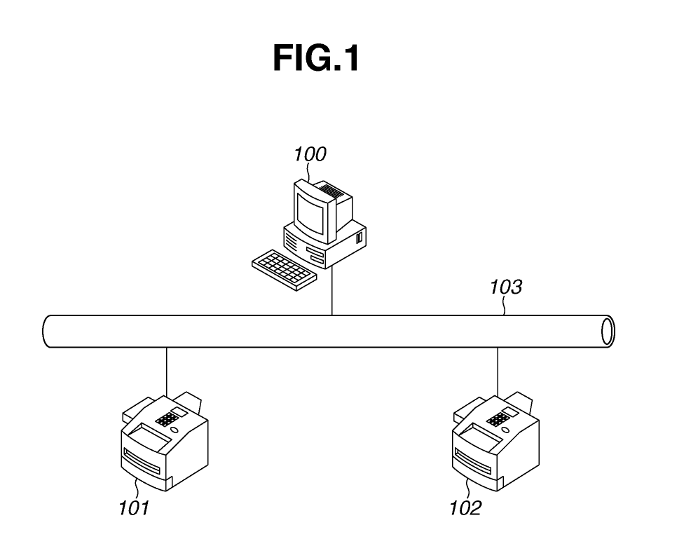

FIG. 1 is a diagram illustrating a configuration of a data processing system including an information processing apparatus according to a first exemplary embodiment. The present exemplary embodiment is directed to the system where the information processing apparatus and an image processing apparatus can communicate with each other via a network. In FIG. 1, the information processing apparatus 100 is a computer used by a user to instruct printing or facsimile transmission to an image processing apparatus 101 and an image processing apparatus 102. The image processing apparatuses 101 and 102 are multifunction peripherals having printer, facsimile, copy, scanner, and file transmission functions.

In the image processing apparatus 100, a predetermined operating system (OS) and various applications for executing specific functions are installed. The specific functions include document processing, spreadsheet processing, presentation processing, image processing, and graphical processing, and each application has its own data structure (file structure).

The OS is configured to instruct printing to a corresponding application by referring to an identifier of each file. In the image processing apparatus 100 according to the present exemplary embodiment, a virtual device application for utilizing the image processing apparatus is installed. The virtual device application has a function of instructing the outputting such as printing or facsimile transmission to the image processing device, and a function of displaying a use state of the image processing apparatus or an execution state of an output job. The apparatuses are connected to a local area network (LAN) 103, and communicate information with each other via the LAN 103.

### [Hardware Configuration (Information Processing Apparatus)]

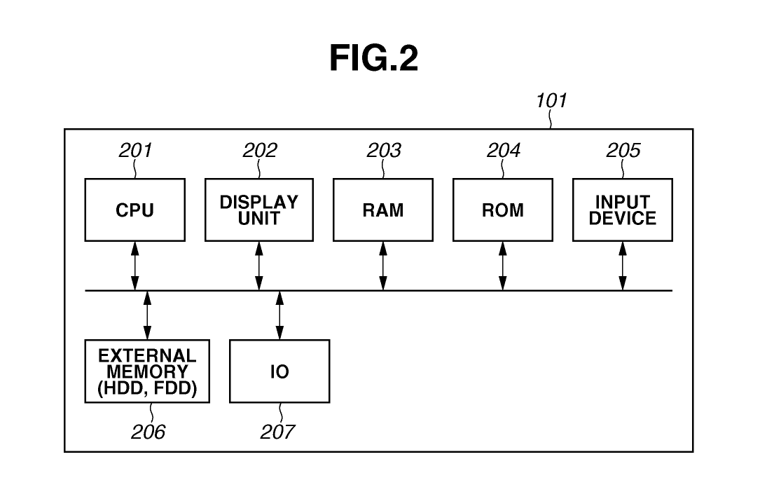

FIG. 2 is a diagram illustrating a hardware configuration of the information processing apparatus 100 illustrated in FIG. 1. In FIG. 2, the image processing apparatus 101 includes an input device 205 such as a keyboard or a pointing device that receives a user's operation input, a display unit 202 that gives a visual output information feedback to the user, a random access memory (RAM) 203, an external memory 206 such as a hard disk drive (HDD) or a flexible disk drive (FDD), and a read-only memory (ROM) 204 as a storage device that stores various programs or execution information of the present exemplary embodiment. The image processing apparatus 101 further includes an interface device I/O 207 that performs communication with an external device, and a central processing unit 201 that executes the programs. Connection with peripheral devices can be performed by wire or wireless. The information processing apparatus 100 is connected to the image processing apparatus 101 or 102 via this external device connection interface (I/F).

### [Software Diagram]

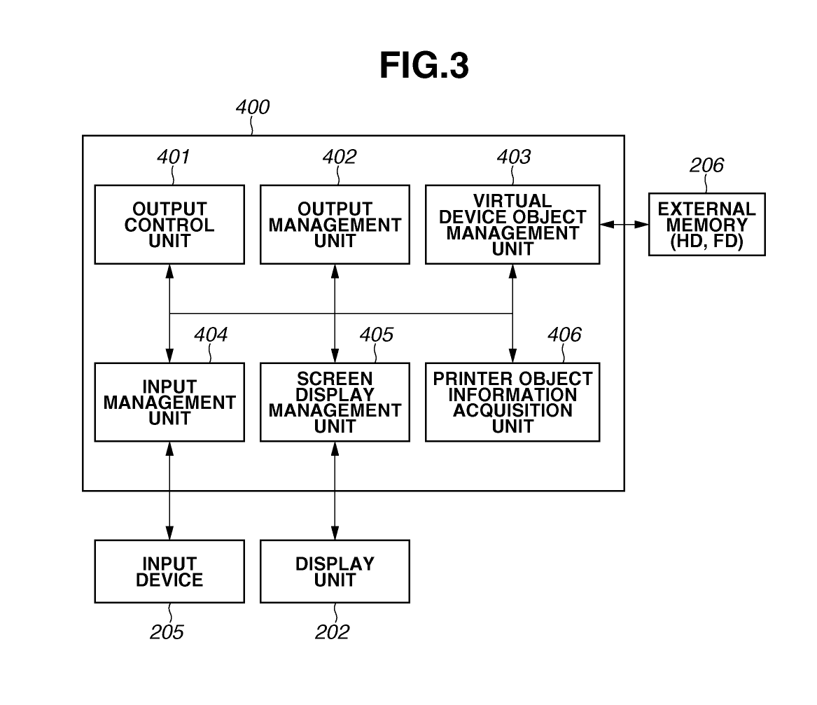

FIG. 3 is a diagram illustrating an example of a functional configuration of a virtual device application 400 executed by the information processing apparatus 100 illustrated in FIG. 1. In FIG. 3, the virtual device application 400 includes an input management unit 404, a screen display management unit 405, a printer object information acquisition unit 406, a virtual device object management unit 403, an output control unit 401, and an output management unit 402. The input management unit 404 detects a user's operation of the input device 205 via a graphical user interface (GUI) of the virtual device application 400 displayed by the screen display management unit 405 to acquire information of the user's operation.

The screen display management unit 405 performs, as the GUI of the virtual device application 400, screen display control such as displaying of a virtual device object or displaying of output selection.

In the present exemplary embodiment, the virtual device object is an object operable by the user displayed on the display unit 202 of the information processing apparatus 100. The virtual device object can be displayed by an OS module operated independently of the virtual device application.

The printer object information acquisition unit 406 acquires information of a printer object managed by the OS or information of a printer driver allocated to the printer object. The printer object information acquisition unit 406 detects a configuration change such as addition or deletion of a printer object carried out by the OS. The printer object information acquisition unit 406 determines whether the printer driver allocated to the printer object can be linked with the virtual device application 400.

As printer objects, there are a printer object for printing, allocated to a printer driver for printing, and a printer object for facsimile transmission allocated to a printer driver for facsimile transmission.

In the present exemplary embodiment, the printer object for printing and the printer object for facsimile transmission are similarly represented as printer objects. Hereinafter, when the printer object for printing and the printer object for facsimile transmission must be clearly differentiated to be used, they will be used separately. When not clearly differentiated, they will be represented as printer objects.

In the present exemplary embodiment, the printer driver for printing and the printer driver for facsimile transmission are similarly represented as printer drivers. Hereinafter, when the printer driver for printing and the printer driver for facsimile transmission must be clearly differentiated to be used, they will be used separately. When not clearly differentiated, they will be represented as printer drivers.

More specifically, IF may be released to control a function of the printer driver from the virtual device application 400. The IF is released as a software development kit (SDK) of the printer driver, and a cooperative operation with the virtual device application 400 is guaranteed. The virtual device application 400 can perform control between itself and the printer driver via the IF. The printer object information acquisition unit 406 determines a possibility of cooperation by determining whether the printer driver includes the IF.

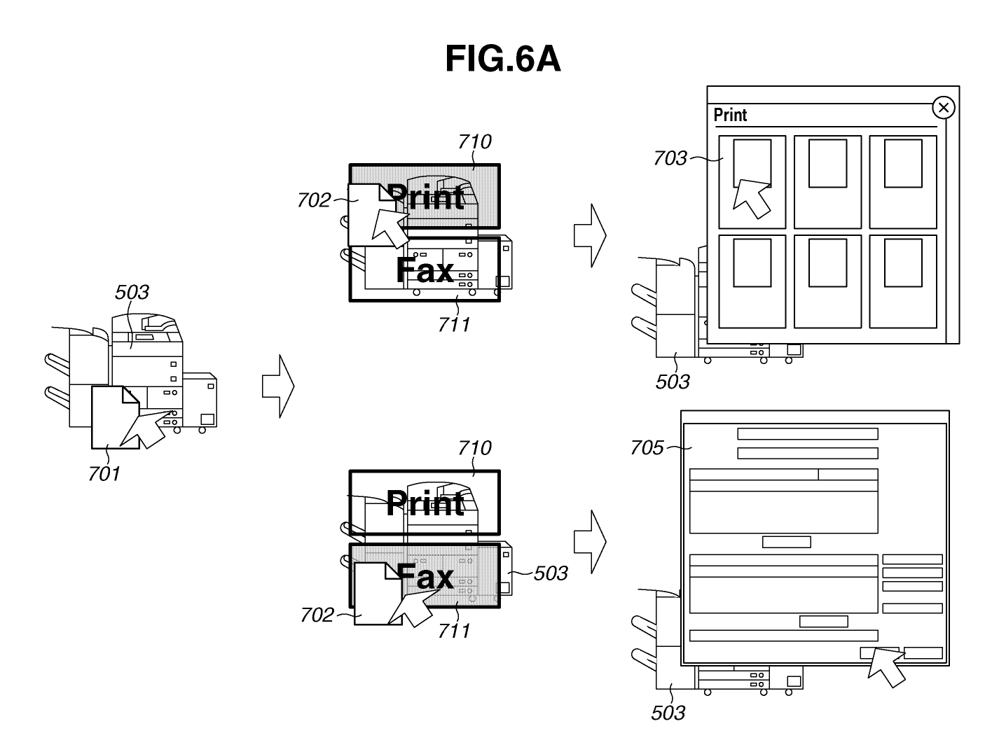

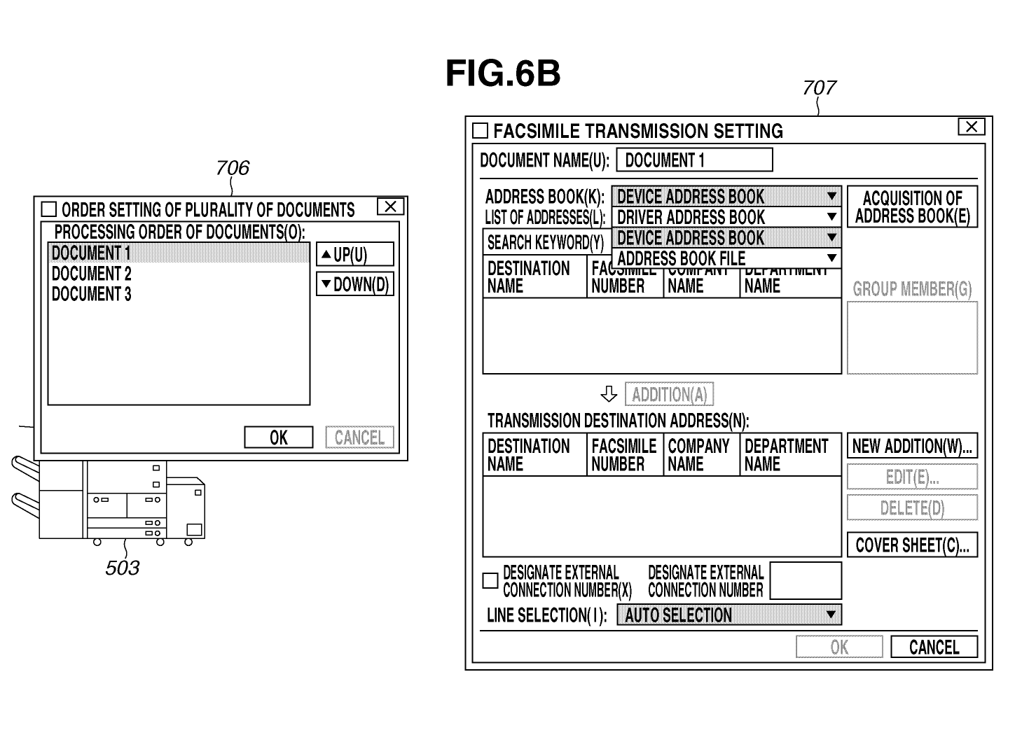

As illustrated in FIGS. 6A and 6B, the virtual device object management unit 403 generates and manages configuration information of the virtual device object. More specifically, the virtual device object management unit 403 constructs a configuration of the virtual device object based on the information of the printer object acquired by the printer object information acquisition unit 406. The virtual device object management unit 403 performs control for writing of setting information about the configuration of the virtual device object or function setting of the virtual device object in a setting file stored in the external memory 206 or reading of the setting information from the setting file.

The output control unit 401, which has received an output instruction from the user via the input management unit 404, issues an output instruction to a printer driver allocated to a corresponding printer object based on the output instruction. The output control unit 401 issues an output instruction to the printer driver for printing in the case of a printing instruction, and to the printer driver for facsimile transmission in the case of facsimile transmission.

The printer driver that has received the instruction converts a file designated by the output instruction into output instruction information interpretable by the image processing apparatus 101 (102). The output instruction information is information converted into a printing data format (e.g., page description language (PDL)) in the case of print outputting, and information converted into a facsimile transmission data format (e.g., raster data) in the case of facsimile transmission. Then, the printer driver transmits the converted output instruction information to the image processing apparatus 101 (102) via the network 103.

### [Printer Object Management Screen of OS and Display Screen of Virtual Device Application]

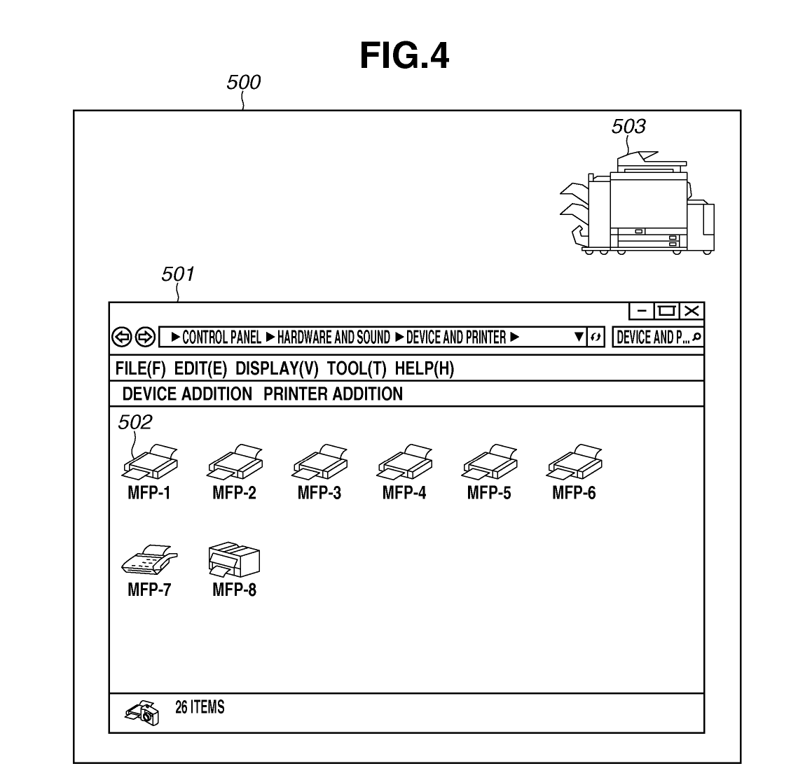

FIG. 4 is a diagram illustrating an example of a UI screen displayed on the display unit 202. This example is a schematic illustration of a printer object management screen of the OS and a display screen of the virtual device application.

FIG. 4 illustrates a desktop screen 500 displayed by the OS, the printer object management screen 501 of the OS, and printer objects (MFP-1 to FMP-8) 502. On the printer object management screen 501, a list of all the printer objects (MFP-1 to FMP-8) installed in the OS is displayed.

After a printer driver has been installed in the OS, a printer object 502 allocated to the printer driver by the OS is displayed on the printer object management screen 501.

A virtual device object 503 is a schematic representation of a display state of a virtual device object in the virtual device application. The virtual device object 503, which is displayed on the desktop of the OS, receives the output instruction from the user. This enables the user to achieve a desired output. In the present exemplary embodiment, in the case of installing a printer driver or the like, the user gives a simple operation instruction, and thus correspondence is set between the installed printer driver and a virtual device object based on a procedure of a flowchart described below.

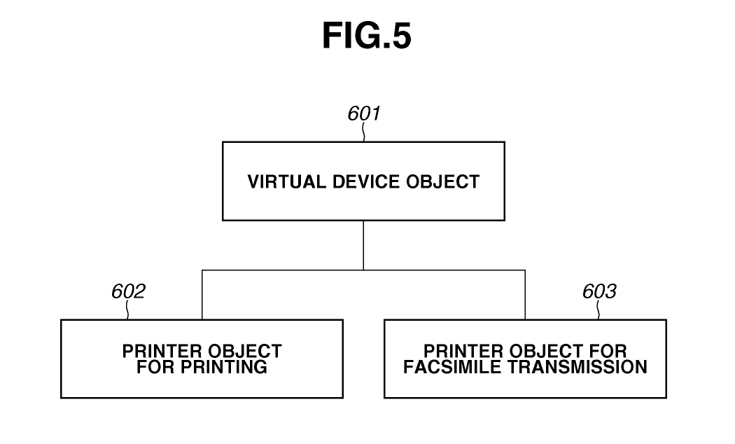

FIG. 5 is a diagram illustrating a relationship between a virtual device object and a printer object.

In FIG. 5, a virtual device object 601 is configured such that a printer object 602 for printing and a printer object 603 for facsimile transmission corresponding to a specific image processing apparatus can be allocated. When a printing instruction is received from the user, outputting is executed via the printer object 602 for printing. In the case of facsimile transmission, the outputting is executed via the printer object 603 for facsimile transmission.

When there is a plurality of image processing apparatuses as in the case of the system configuration of the present exemplary embodiment, one virtual device object 503 can be generated for each of the image processing apparatuses 101 and 102. A printer object of the image processing apparatus 101 and a facsimile transmission printer object of the image processing apparatus 102 can be allocated to one virtual device object 503.

### [Display UI During Output Execution of Virtual Device Application]

FIGS. 6A and 6B are diagrams each illustrating a change state of the UI screen displayed on the display unit 202 illustrated in FIG. 2. This example is a schematic illustration of the display UI during output execution of the virtual device application.

In FIGS. 6A and 6B, the virtual device application, which has accepted user's dragging of a file 701 to the virtual device object 503 illustrated in FIG. 4, displays an output selection display portion 710 and an output selection display portion 711. The dragging of the file 701 to the virtual device object 503 corresponds to an instruction of linking the file 701 to the virtual device object 503.

In the present exemplary embodiment, the output selection display portions 710 and 711 are display regions on the virtual device object 503 for accepting user's file dropping. The display regions are classified into a print portion for receiving a printing instruction (corresponding to an output selection display portion 710) and a facsimile portion for receiving a facsimile transmission instruction (corresponding to an output selection display portion 711).

Then, the user drags and drops a file 702 onto a place for outputting to be executed (the output selection display portion 710 or 711) to detect an execution instruction, thereby achieving desired outputting. The virtual device application, which has accepted the dropping operation of the file 702 onto the print portion (the output selection display portion 710), displays a print setting screen 703 for designating print setting. The user selects the print setting to issue a printing instruction to the image processing apparatus.

The virtual device application, which has accepted the dropping operation of the file 702 onto the facsimile portion (the output selection display portion 711), displays a destination designation screen 705 for facsimile transmission. The user designates a destination and perform a relevant execution operation, thereby issuing a facsimile transmission instruction to the image processing apparatus.

UI screens displayed on the print setting screen 703 and the destination designation screen 705 can be realized either by a configuration of displaying a UI managed by the virtual device application or a configuration of calling up a UI of a printer object corresponding to a virtual device object. In the case of accepting a dropping operation of a plurality of document files, as illustrated in FIG. 6B, a UI screen 706 for designating an output order of the document files is displayed. The user designates an output order, and thus an output instruction is executed according to the designated order.

The virtual device application is configured to limit use of the application by license authentication. For example, when a license is not valid due to expiration of a use period, usable functions are limited.

In the case of designating a destination on the facsimile transmission destination screen 707, destinations can be referred to in the address book managed by the image processing apparatus, the address book managed by the driver, and the address book file. The virtual device application, which has accepted a dropping operation onto the facsimile transmission portion, confirms validity of the license. When invalid, the address book managed by the image processing apparatus cannot be selected.

### [Display UI at the Time of Adding/Changing of Virtual Device Object]

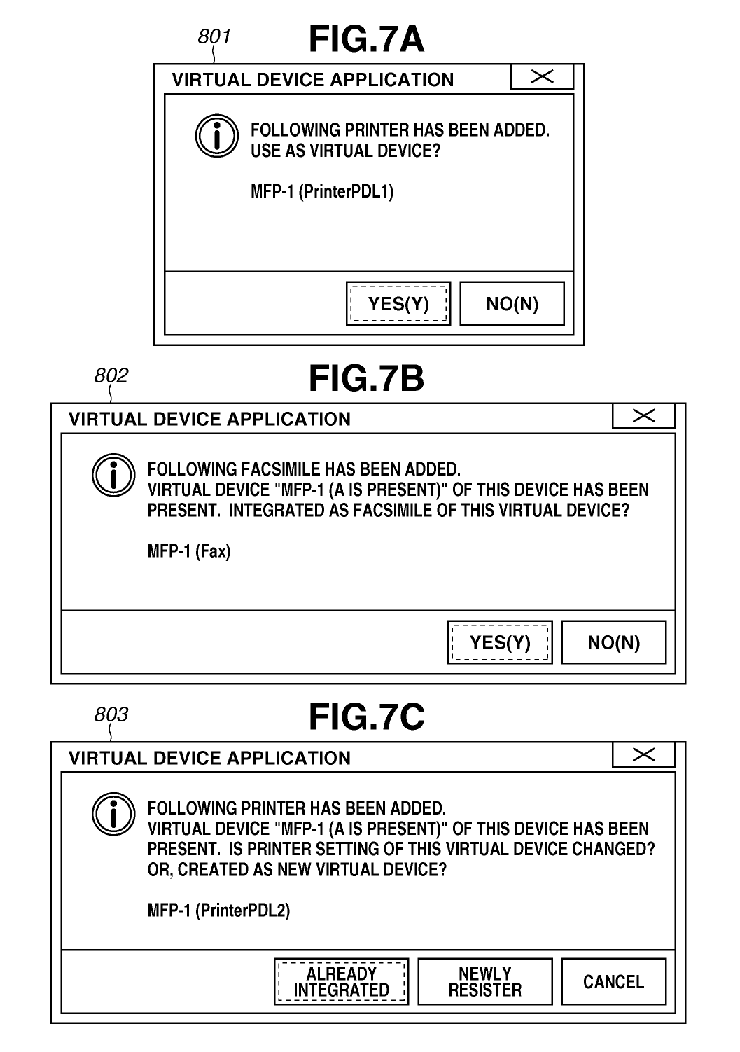

FIG. 7 is a diagram illustrating an example of the UI screen displayed on the display unit 202 illustrated in FIG. 2. This example is a schematic illustration of a screen for checking, when a printer object is added to the OS, with the user whether to use the printer object as a virtual device application.

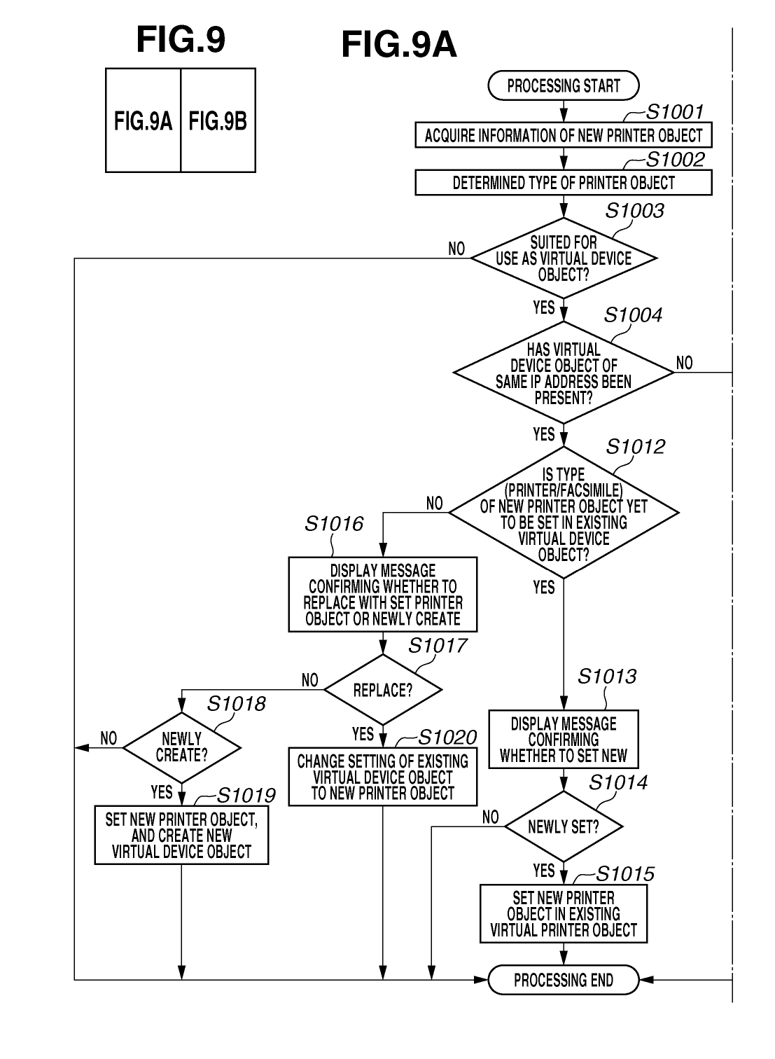

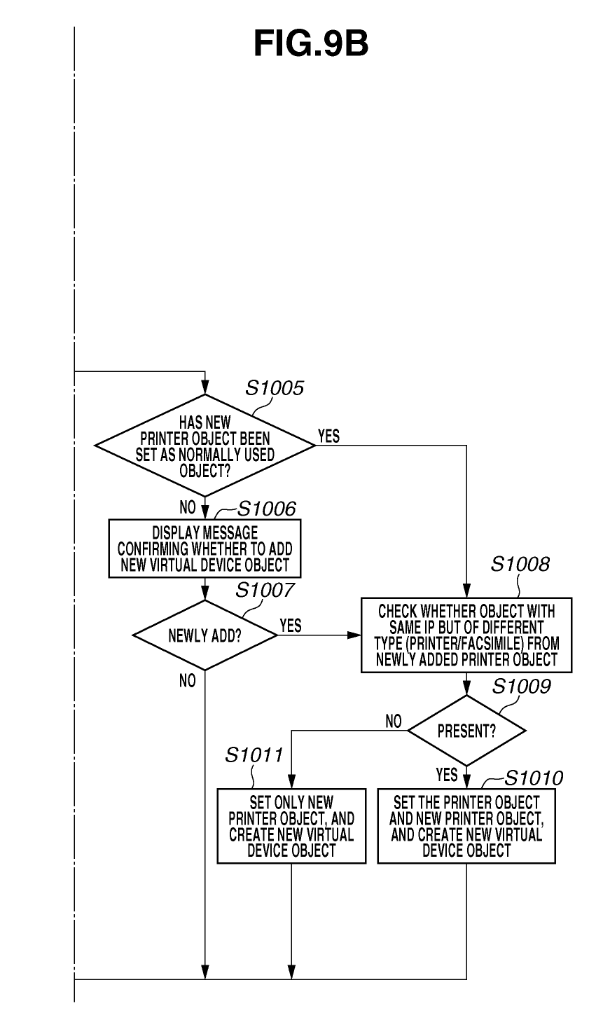

In FIG. 7, a confirming screen 801 displayed in step S1006 illustrated in FIG. 9 is a screen example for checking, when a new printer object is added to the OS, with the user whether to use it as a new virtual device object if its corresponding device is not being used as a virtual device object. In the present exemplary embodiment, an example of displaying a different confirming screen according to the procedure of the flowchart illustrated in FIG. 9 described below, i.e., according to a registered state of a printer driver with respect to an operated device object, will be described.

Checking screens 802 and 803 respectively displayed in step S1013 and step S1016 of FIG. 9 as described below are screen examples for confirming, if its corresponding device has been used as a virtual device object, whether to change to a printer object to which setting of the existing virtual device object has been added, when a new printer object is added to the OS. In this case, a name of the relevant virtual device object is presented. A name of a printer object allocated when creating a virtual device object, is set as an initial value, however, this name can be arbitrarily changed by the user.

### [Newly Added Printer Object Detection Processing]

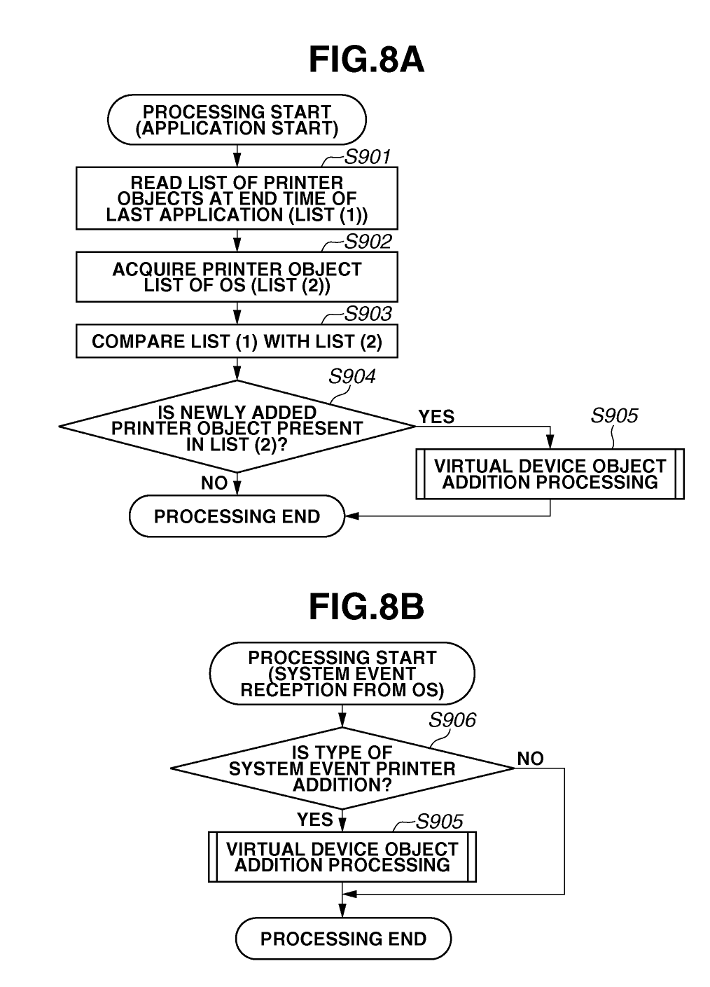

FIGS. 8A and 8B are flowcharts each illustrating a method for controlling the information processing apparatus according to the present exemplary embodiment. This example is a newly added printer object detection processing of the virtual device application 400. More specifically, it is processing for detecting addition of a new printer object to the OS, for example, in the case of installing a driver.

Steps S901 to S905 illustrated in FIG. 8A and steps S905 and S906 illustrated in FIG. 8B are performed by loading the virtual device application 400 or a program such as a printer driver stored in the ROM 204 or the external memory 206 to the RAM 203 to execute it by the CPU 201. The processing is executed after the virtual device application 400 has accepted a start instruction. Further, in the case of the activation of the virtual device application 400, the processing is executed after receiving a notification of a system changing event of the OS. Hereinafter, steps illustrated in FIGS. 8A and 8B are executed by the CPU 201. For convenience, the steps will be described mainly based on the modules illustrated in FIG. 3.

In FIG. 8A, after the virtual device application 400 has been activated, in step S901, the virtual device object management unit 403 reads a list (hereinafter, list (1)) of printer objects of the OS at the end time of a last application. This is processing for reading the list of printer objects of the OS stored in a setting file (not illustrated) by the virtual device object management unit 403 at the end time of an application. The list of printer objects of the OS is a list of names of the printer objects installed in the OS. In step S902, the printer object information acquisition unit 406 makes a request to the OS to acquire a printer object list (hereinafter, list (2)) of the OS. In step S903, the virtual device object management unit 403 compares the list (1) with the list (2). The list (1) and the list (2) are lists of names of the printer objects, specifically lists of names (“MFP-1”, etc.) of printer objects of printer objects 502 in the example illustrated in FIG. 4. The comparison processing is character string comparison as to the names. If the virtual device object management unit 403 determines that a newly added printer object is present (if there is printer object present in list (2) but not in list (1)) (YES in step S904), the processing proceeds to step S905.

On the other hand, if the virtual device object management unit 403 determines that no newly added printer object is present (not present in list (1)) (NO in step S904), the processing ends.

In step S905, the newly added printer object is added as a virtual device objet. This processing will be described in detail below referring to FIG. 9. On the other hand, during the activation of the virtual device object management unit 403, a new printer object may be added to the OS. In this case, a system changing event of the OS can be detected.

In step S906 illustrated in FIG. 8B, the virtual device object management unit 403, which has accepted the system changing event of the OS by the printer object information acquisition unit 406, refers to a type of the event to determine whether to add a printer object. In the case of adding printer object (YES in step S906), the processing proceeds to step S905. In another case (NO in step S906), the processing ends. The processing of step S905 will be described in detail below referring to FIG. 9.

### [Addition Processing of Virtual Device Object]

FIG. 9 is a flowchart illustrating the method for controlling the information processing apparatus according to the present exemplary embodiment. This example is an addition processing of a virtual device object of the virtual device application 400. More specifically, it is processing for adding, if a printer object newly added to the OS is present, the printer object as a virtual device object of the virtual device application 400. Steps S1001 to S1020 are realized by the CPU 201 loading and executing the virtual device application 400 or a program such as a printer driver stored in the ROM 204 or the external memory 206 to the RAM 203.

This processing is executed if a newly added printer object is present, as a result of the processing illustrated in FIGS. 8A and 8B. The steps illustrated in FIGS. 8A and 8B are executed by the CPU 201. The steps will be described mainly based on the modules illustrated in FIG. 3.

In step S1001, the printer object information acquisition unit 406 acquires information of a printer object based on a name of a newly added printer object (hereinafter, the printer object which is a current processing target). The information acquired in this case is property information such as a type of an output port or an Internet protocol (IP) address acquired from the OS.

In step S1002, the printer object information acquisition unit 406 determines a type of the printer object. The type of the printer object is a type of an output as a printing instruction or a facsimile transmission instruction.

Next, determination processing will specifically be described.

First, initialization of an IF (interface) of a printer driver allocated to a printer object is tried. In the initialization processing, the program IF of the printer driver is called up via a printer driver Software Development Kit (SDK) to acquire configuration information of the printer driver. If the acquisition of the configuration information of the printer driver is successful, configuration information indicating successful calling of the program IF can be acquired.

On the other hand, if a program IF has not been provided, for example, in the case of other company's printer driver and calling of the program is impossible, the processing fails. If the initialization processing is successful, further configuration information of the printer driver is acquired.

Information about an output type is defined in the acquired configuration information. The output type can be determined by referring to the configuration information. The output types are, for example, a print output, a facsimile output, and a file output. In step S1003, the virtual device object management unit 403 determines, based on the type of the print object acquired by the printer object information acquisition unit 406 in step S1002, whether the printer object as the current processing target can be suitably used as a virtual printer object. The type of the printer object suitably used as the virtual printer object is print outputting or facsimile transmission.

Other printer objects including those in the case of the failure of the IF initialization and the type for file outputting are excluded as unsuited. If the virtual device object management unit 403 determines that the current processing target printer object can be suitably used as the virtual printer object (YES in step S1003), the processing proceeds to step S1004. If the virtual device object management unit 403 determines otherwise (NO in step S1003), the processing ends.

In FIG. 9, if the virtual device object management unit 403 determines that printer object cannot be suitably used as the virtual printer object (NO in step S1003), the processing ends without creating any virtual device object. Otherwise, in place of steps S1001 to S1020, only step S1011 may be executed. In step S1004, the virtual device object management unit 403 refers to information of the created virtual device object to determine whether any virtual device object of the same IP address is already present (registered) (second determination).

Specifically, the virtual device object management unit 403 determines whether any virtual device object having the same IP address is present by referring to the address information of the printer object acquired in step S1001. The virtual device object having the same IP address means a virtual device object to which a virtual device object having an IP address similar to that of the printer object acquired in step S1001 has been allocated. If the virtual device object management unit 403 determines that a virtual device object having the same IP address is already present (YES in step S1004), the processing proceeds to step S1012. If the virtual device object management unit 403 determines otherwise (NO in step S1004), the processing proceeds to step S1005.

The address information is specified by, for example, the IP address. However, the address information can be represented by a name (domain name or host name).

In step S1005, the virtual device object management unit 403 refers to the printer object information acquired in step S1001 to determine whether the printer object has been set to be “normally used”. The “normally used” setting means OS setting, which indicates a printer object designated as default in the printing. In a specific OS, a check mark may be added to the printer object, thereby enabling checking of a “normally used” state.

FIG. 9 illustrates an example where if a new printer objet is not set to be normally used in step S1005, and no new printer object is added in step S1007 described below, no virtual device object is created. Otherwise, however, if it is determined that no virtual device object having the same IP address is present (NO in step S1004) without making the determination of step S1005, the processing can proceed to step S1008 or S1011.

If the virtual device object management unit 403 determines that the new printer object is set to be “normally used” (YES in step S1005), the processing proceeds to step S1008. In the case of the “normally used” setting, the printer object is regarded as an object to be preferentially used by the user, and the processing proceeds to newly creating a virtual device object without checking with the user.

On the other hand, if the virtual device object management unit 403 determines that the new printer object is not set to be “normally used” (NO in step S1005), the processing proceeds to step S1006. The screen display management unit 405 is instructed to display a message (confirming screen 801 illustrated in FIG. 7) for confirming whether to newly create a current processing target printer object as a virtual device object and use it. Then, in step S1007, the virtual device object management unit 403 determines whether new creation (new addition) has been selected by the user as a result of the message. The user selects a yes (Y) button or a no (N) button displayed on the confirming screen 801 to instruct new creation.

If the virtual device object management unit 403 determines that the new creation has been selected (YES in step S1007), the processing proceeds to step S1008. If otherwise (NO in step S1007), the processing ends.

In step S1008, the virtual device object management unit 403 instructs the printer object information acquisition unit 406 to determine whether a printer object of the same IP address but a different type is present in the printer object installed in the OS. The different type indicates a different type of a printer object. For example, if the printer object as a current processing target is for print outputting, it is confirmed whether any printer object for facsimile transmission is present.

If as a result of step S1008, the virtual device object management unit 403 determines that a printer object of a different type is present (YES in step S1009), the processing proceeds to step S1010. If the virtual device object management unit 403 determines otherwise (NO in step S1009), the processing proceeds to step S1011. In step S1010, the virtual device object management unit 403 creates a new virtual device object including both of the current processing target printer object and the printer object of the different type determined in step S1008, and the processing ends. This is a virtual device object to which both printer objects for printing and facsimile transmission are allocated.

On the other hand, in step S1011, the virtual device object management unit 403 creates a new virtual device object including only the current processing target printer object, and the processing ends.

On the other hand, if the virtual device object management unit 403 has determined that a virtual device object of the same IP address is already present (YES in step S1004), and the processing proceeds to step S1012, the virtual device object management unit 403 determines whether a printer object of the same type as that of the current processing target printer object has been set in the virtual device object.

A reason for considering whether a printer object of the same type has been set in the virtual device object is, for example, a plurality of types of printer objects for printing may be present in the same model. Specifically, for example, a case is possible where as to printer objects for printing, printer objects of different page description languages (PDL 1 and PDL 2) may be present in the same device.

If the virtual device object management unit 403 determines that a printer object of the same type as that of the current processing target printer object has not been set (NO in step S1012), the processing proceeds to step S1013. If the virtual device object management unit 403 determines otherwise (YES in step S1012), the processing proceeds to step S1016. In step S1013, the virtual device object management unit 403 instructs the screen display management unit 405 to display a message (confirming screen 802 illustrated in FIG. 7) for confirming whether to set the printer object to be used in an existing virtual device object. Then, the user selects a yes (Y) button or a no (N) button displayed on a confirming screen 802.

If it is determined that “setting” has been selected by the user, the processing proceeds to step S1015. If otherwise, the processing ends.

In step S1015, the virtual device object management unit 403 changes a setting content of the existing virtual device object to a state where the printer object is set, and the processing ends.

On the other hand, in step S1016, the virtual device object management unit 403 instructs the screen display management unit 405 to display a message (confirming screen 803 illustrated in FIG. 7) for confirming whether to change setting of the existing virtual device object to the current processing target printer object or to create a new virtual device object. Then, the user selects a new registration button or an integration button displayed on the confirming screen 803. If it is determined that “unsetting” has not been selected (NO in step S1012), step S1020 can be executed without displaying the confirming screen 803 in step S1016.

In step S1017, the virtual device object management unit 403 determines whether “changing (integration with an existing object)” has been selected by the user. If the virtual device object management unit 403 determines that “changing” has been selected by the user (YES in step S1017), in step S1020, the virtual device object management unit 403 changes setting of the existing virtual device object to the current processing target printer object, and the processing ends. On the other hand, if the virtual device object management unit 403 determines that “changing” has not been selected by the user (NO in step S1017), in step S1018, the virtual device object management unit 403 determines whether “new creation” has been selected by the user. If the virtual device object management unit 403 determines that “new creation” has been selected by the user (YES in step S1018), in step S1019, the virtual device object management unit 403 creates a new virtual device object including the current processing target printer object, and the processing ends.

On the other hand, if the virtual device object management unit 403 determines that “new creation” has not been selected by the user (NO in step S1018), the processing ends. Accordingly, by instructing installation of the printer driver, the user can register the printer driver in the virtual device object in an state where the printer driver is adapted to a system environment intended by the user. As a result, loads of individual registration in the virtual device object after the user has registered the printer driver, can be reduced.

Each process of the present invention can be achieved by by a processing apparatus (CPU or processor) such as a personal computer (computer) executing software (program) acquired via a network or various storage media.

The present invention is not limited to the exemplary embodiments. Various changes (including organic combinations of exemplary embodiments) can be made based on a gist of the invention, and these changes are within the present invention.

According to the present invention, by determining addition of a printer object, the printer object can be registered in the virtual device object by a simple operation.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-030676 filed Feb. 20, 2013, which is hereby incorporated by reference herein in its entirety.

What is claimed is:

1. An information processing apparatus comprising:
a determination unit configured to determine whether any printer object has been added;
a creation unit configured to create, if the determination unit determines that a printer object has been added, a virtual device object corresponding to the added printer object; and
an instruction unit configured to receive from a user an instruction for linking a file to the created virtual device object,
wherein a printer driver corresponding to the printer object outputs output information to an image processing apparatus after the instruction unit has accepted the received instruction from the user for linking the file to the virtual device object.

2. The information processing apparatus according to claim 1, further comprising a second determination unit configured to determine whether any virtual device object having the same address information as that of a printer object to be added is present,
wherein, if the second determination unit determines that no virtual device object having the same address information as that of the printer object to be added is present, the creation unit creates a new virtual device object corresponding to the added printer object.

3. The information processing apparatus according to claim 1, further comprising:
a second determination unit configured to determine whether any virtual device object having the same address information as that of a printer object to be added is present;
a determination unit configured to determine, if the second determination unit determines that a virtual device object having the same address information as that of the printer object to be added is present, whether any printer object of the same type as that of the printer object to be added has been registered; and
a management unit configured to replace, if the determination unit determines that a printer object of the same type has been registered, the registered printer object with the printer object to be added, and newly add the printer object to be added if the determination unit determines that no printer object of the same type has been registered.

4. The information processing apparatus according to claim 1, further comprising a display unit configured to display, if the determination unit determines that the printer object has been added and determines that determination by a user is necessary, a confirming screen concerning the virtual device object.

5. A method for controlling an information processing apparatus, the method comprising:
determining whether any printer object has been added;
creating, if it is determined that a printer object has been added, a virtual device object corresponding to the added printer object; and
receiving from a user an instruction for linking a file to the created virtual device object,
wherein a printer driver corresponding to the printer object outputs output information to an image processing apparatus after accepting the received instruction from the user for linking the file to the virtual device object.

6. The method according to claim 5, further comprising determining whether any virtual device object having the same address information as that of a printer object to be added is present,
wherein, if it is determined that no virtual device object having the same address information as that of the printer object to be added is present, creating includes creating a new virtual device object corresponding to the added printer object.

7. The method according to claim 5, further comprising:
determining whether any virtual device object having the same address information as that of a printer object to be added is present;
determining, if it is determined that a virtual device object having the same address information as that of the printer object to be added is present, whether any printer object of the same type as that of the printer object to be added has been registered; and
replacing, if it is determined that a printer object of the same type has been registered, the registered printer object with the printer object to be added, and newly add the printer object to be added if it is determined that no printer object of the same type has been registered.

8. The method according to claim 5, further comprising displaying, on a display unit and if it is determined that the printer object has been added and determines that determination by a user is necessary, a confirming screen concerning the virtual device object.

9. A non-transitory recording medium storing a program to cause an information processing apparatus to perform a method, the method comprising:
determining whether any printer object has been added;
creating, if it is determined that a printer object has been added, a virtual device object corresponding to the added printer object; and
receiving from a user an instruction for linking a file to the created virtual device object,
wherein a printer driver corresponding to the printer object outputs output information to an image processing apparatus after accepting the received instruction from the user for linking the file to the virtual device object.
